(19) United States
(12) Patent Application Publication
(10) Pub. No.: US 2022/0414720 A1
(43) Pub. Date: Dec. 29, 2022

(54) SYSTEMS AND METHODS FOR FACILITATING RESERVATION TRADING

(71) Applicant: Capital One Services, LLC, McLean, VA (US)

(72) Inventors: Allison Fenichel, Brooklyn, NY (US); Jacob Balgoyen, Arlington, VA (US); Daniel Marsch, Sterling, VA (US); Lin Ni Lisa Cheng, New York, NY (US); Viraj Chaudhary, Katy, TX (US); Isaac Yi, Arlington, VA (US)

(21) Appl. No.: 17/358,032

(22) Filed: Jun. 25, 2021

(51) Int. Cl. G06Q 30/02; G06Q 10/02; G06Q 30/06; G06F 3/0484; G06F 3/0482

(52) U.S. Cl. CPC G06Q 30/0283; G06Q 10/02; G06Q 30/0201; G06Q 30/0611; G06F 3/04842; G06F 3/0482

(57) ABSTRACT

A system may include processor(s), a memory in communication with the processor(s), and storing instructions, that when executed by the processor(s), are configured to cause the system to facilitate reservation trading. The system may identify an upcoming reservation and a booking rate of the reservation. The system may receive comparable reservation list rates to generate a predicted list rate of the reservation. The system may suggest the first user request a refund or place the reservation on an exchange based on whether the reservation is refundable and whether the predicted list rate is greater than the booking rate. The system may receive a resell rate from the first user to transmit to a second user. The system may receive a selection of the reservation and payment information from the second user. The system may process the payment information and transfer the reservation from the first user to the second user.

### FIELD

The disclosed technology relates to systems and methods for reservation trading, and more particularly for providing an online exchange for customer-to-customer reservation negotiation and trading.

### BACKGROUND

Reservation rates (e.g., hotel room rates) can vary significantly based on demand, source of booking, geographic region, season, and many other factors. Customers also regularly find themselves in situations where personal circumstances require them to move or cancel a booked reservation. Cancellation policies can vary widely based on, for example, merchant and geographic region. That is, while some policies allow customers to make changes to or cancel a reservation up to, e.g., 24 or 48 hours prior to a reservation date, other policies require change or cancellation fees, especially if a customer received some form of discounted rate upon booking. In any of these situations, customers may find it beneficial to transfer a reservation to another customer to either avoid a fee or to simply make some money.

Accordingly, there is a need for improved systems and methods that allow a first customer who has already made a reservation, to sell and transfer that reservation to a second customer. Embodiments of the present disclosure are directed to this and other considerations.

### SUMMARY

Disclosed embodiments provide systems and methods for facilitating reservation trading that enable a first customer to transfer a reservation to a second customer, wherein the first and second customers may also negotiate reservation pricing.

Consistent with the disclosed embodiments, a system may include one or more processors and a memory in communication with the one or more processors and storing instructions, that when executed by the one or more processors, are configured to cause the system to perform a method for facilitating reservation trading. For example, the system may receive data (e.g., transaction data) associated with a first user, and may identify an upcoming reservation, such as a hotel room reservation, based on that data. The system may identify a booking rate at which the first user made the upcoming reservation. The system may receive one or more comparable reservation list rates (based on, e.g., current market rates), and based on those comparable list rates, may generate a predicted list rate of the upcoming reservation. The system may determine whether the predicted list rate of the upcoming reservation is greater than the booking rate by a predetermined threshold (e.g., 10%, 15%, 20%, etc.). The system may also determine, based on a refund policy associated with the upcoming reservation, whether the booking rate is refundable. Responsive to determining the booking rate is refundable and the predicted list rate is not greater than the booking rate by the predetermined threshold, the system may transmit a first message (e.g., via email, SMS messaging, a push notification, an application, etc.) to a first customer device (e.g., a mobile phone, a laptop computer, etc.) associated with the first user to request a refund for the booking rate. Responsive to determining the booking rate is not refundable or the predicted list rate is greater than the booking rate by the predetermined threshold, the system may transmit a second message to the first customer device to place the upcoming reservation in an exchange, such as an online secondary marketplace. The system may receive, from the first customer device, a response indicating interest in placing the upcoming reservation in the exchange. The system may receive, from the first customer device, a resell rate for the upcoming reservation. The system may then transmit the resell rate to a second customer device associated with a second user for display via a graphical user interface (GUI). The system may receive, from the second customer device, a selection of the upcoming reservation. The system may also receive payment information from the second customer device. The system may process the payment information and may then transfer the upcoming reservation from the first user to the second user. The system may then credit an account of the first user based on the received payment information and an agreed upon rate.

In another embodiment, a system may include one or more processors and a memory in communication with the one or more processors and storing instructions, that when executed by the one or more processors, are configured to cause the system to perform a method for facilitating reservation trading. For example, the system may receive data (e.g., transaction data) associated with a plurality of users, and may identify an upcoming reservation associated with a first user of the plurality of users based on that data. The system may identify a booking rate at which the first user made the upcoming reservation. The system may receive one or more comparable reservation list rates, and based on those comparable list rates, may generate a predicted list rate of the upcoming reservation. The system may determine whether the predicted list rate of the upcoming reservation is greater than the booking rate by a predetermined threshold. Responsive to determining the predicted list rate is greater than the booking rate by the predetermined threshold, the system may transmit a first message to a first customer device associated with the first user to place the upcoming reservation in an exchange. The system may receive, from the first customer device, a resell rate for the upcoming reservation. The system may then transmit the resell rate to a second customer device associated with a second user for display via a GUI. The system may receive, from the second customer device, a selection of the upcoming reservation, the selection including a counteroffer. The system may receive, from the first customer device, a response indicating acceptance of the counteroffer. The system may receive, from the second customer device, payment information. The system may process the payment information and may then transfer the upcoming reservation from the first user to the second user. The system may then credit an account of the first user based on the received payment information. This embodiment provides the added benefit of enabling users to negotiate reservation rates prior to the acceptance and transfer of reservations.

In another embodiment, a system may include one or more processors and a memory in communication with the one or more processors and storing instructions, that when executed by the one or more processors, are configured to cause the system to perform a method for facilitating reservation trading. For example, the system may receive data associated with a first user. The system may identify an upcoming hotel room reservation based on that data. The system may transmit a first message to a first customer device associated with the first user to place the upcoming hotel room reservation in an exchange. The system may receive, from the first customer device, a response indicating interest in placing the upcoming hotel room reservation in the exchange. The system may transmit booking information associated with the upcoming hotel room reservation to a second customer device associated with a second user for display via a GUI. The system may receive, from the second customer device, a selection of the upcoming hotel room reservation. The system may also receive payment information from the second customer device, and may process the payment information. The system may transfer the upcoming hotel room reservation from the first user to the second user. The system may credit an account of the first user based on the received payment information and an agreed upon rate.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a block diagram of an example system environment that may be used to implement one or more embodiments of the present disclosure;

FIG. 2 is a component diagram of a trading system in accordance with some embodiments of the present disclosure;

FIGS. 3A-3B are a flowchart of a method for facilitating reservation trading, in accordance with some embodiments of the present disclosure;

FIG. 4 is a flowchart of a method for facilitating reservation trading, in accordance with some embodiments of the present disclosure; and

FIG. 5 is a flowchart of a method for facilitating reservation trading, in accordance with some embodiments of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

By way of introduction, aspects discussed herein may relate to systems and methods for facilitating reservation trading between customers. For example, some embodiments describe identifying whether a customer may want to request a refund for an upcoming reservation or place the upcoming reservation in a resale exchange based on a refund policy associated with the upcoming reservation, and on whether a predicted list rate is greater than the original booking rate by a predetermined threshold. These provide advantages over other systems and methods by allowing customers to transfer already-booked reservations to other customers, either at an initially chosen resale rate or at a negotiated rate. As such, the following discussion describes several exemplary systems and methods for facilitating reservation trading and negotiation between customers.

Reference will now be made in detail to example embodiments of the disclosed technology that are illustrated in the accompanying drawings and disclosed herein. Wherever convenient, the same reference numbers will be used throughout the drawings to refer to the same or like parts.

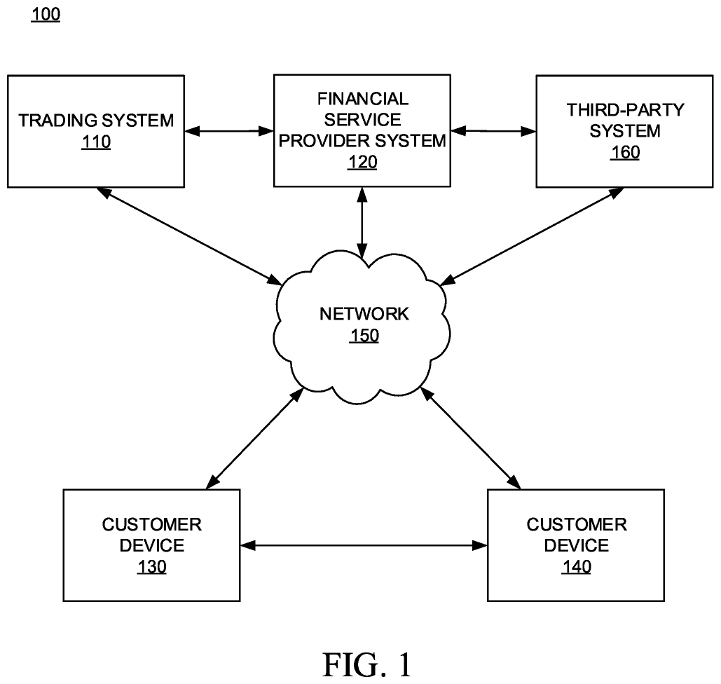

FIG. 1 is a diagram of an example system environment that may be used to implement one or more embodiments of the present disclosure. The components and arrangements shown in FIG. 1 are not intended to limit the disclosed embodiments as the components used to implement the disclosed processes and features may vary.

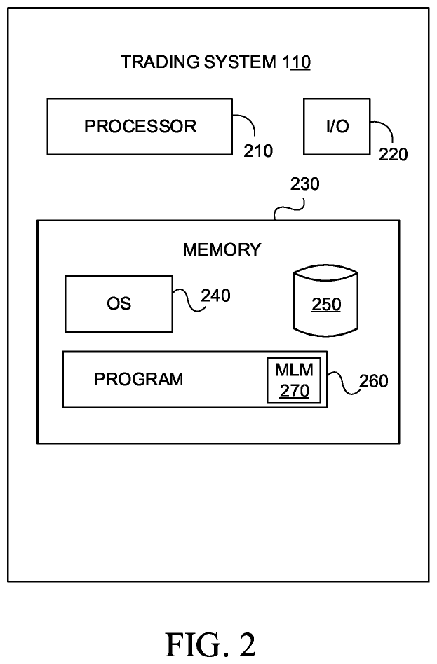

In accordance with disclosed embodiments, system 100 may include a trading system 110 (as will be discussed in more detail below with reference to FIG. 2) that may be in communication (either directly or via a network 150) with a financial service provider system 120. System 100 may also include a customer device 130 and a customer device 140 that may be in communication (either directly or via a network 150) with each other, financial service provider system 120, and/or trading system 110. System 100 may also include a third-party system 160, for example, owned and/or operated by an external entity (e.g., a hotel).

In certain embodiments, financial service provider system 120 may store and/or have access to detailed customer information, such as booked hotel room reservations. Financial service provider system 120 may communicate with trading system 110 to correlate compiled data, analyze the compiled data, arrange the compiled data, generate derived data based on the compiled data, and store the compiled and derived data in a database. Financial service provider system 120 may also communicate with trading system 110 to provide one or more GUI displays to enable customer device 130 and/or 140 to input data, search for data, transfer data, and transmit and receive payments.

Customer device 130 and/or 140 may be a mobile computing device (e.g., a smart phone, tablet computer, smart wearable device, portable laptop computer, voice command device, wearable augmented reality device, or other mobile computing device), a stationary device (e.g., desktop computer), or any other device capable of communicating with network 150 and ultimately communicating with one or more components of system 100. In some embodiments, customer device 130 and/or 140 may include or incorporate electronic communication devices for hearing or vision impaired users. Customer device 130 and/or 140 may be operated by a user, which may include individuals such as, for example, subscribers, clients, prospective clients, or customers of an entity associated with an organization, such as individuals who have obtained, will obtain, or may obtain a product, service, or consultation from an entity associated with system 100. According to some embodiments, customer device 130 and/or 140 may include an environmental sensor for obtaining audio or visual data, such as a microphone and/or digital camera, a geographic location sensor for determining the location of the device, an input/output device such as a transceiver for sending and receiving data, a display for displaying digital images, one or more processors including a sentiment depiction processor, and a memory in communication with the one or more processors.

In accordance with certain embodiments, customer device 130 and/or 140 may also be in communication with third-party system 160 via network 150. In certain embodiments, third-party system 160 may include a computer system associated with an entity (other than the entity associated with system 100 and its users) that performs one or more functions associated with the customers.

Network 150 may be of any suitable type, including individual connections via the internet such as cellular or WiFi networks. In some embodiments, network 150 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

An example embodiment of trading system 110 is shown in more detail in FIG. 2. As shown, trading system 110 may include a processor 210, an input/output (“I/O”) device 220, a memory 230 containing an operating system (“OS”) 240, a database 250, and a program 260. In some embodiments, program 260 may include a machine learning model (“MLM”) 270 that may be trained, for example, to recognize customer behavior patterns (and deviations from typical patterns) based on past and/or pending credit card purchases, purchase location data, and/or other available information. In certain implementations, MLM 270 may issue commands in response to processing an event, in accordance with a model that may be continuously or intermittently updated. Moreover, processor 210 may execute one or more programs (such as via a rules-based platform or the trained MLM 270), that, when executed, perform functions related to disclosed embodiments.

Trading system 110 may be a single server or may be configured as a distributed computer system including multiple servers or computers that interoperate to perform one or more of the processes and functionalities associated with the disclosed embodiments. In some embodiments, trading system 110 may further include a peripheral interface, a transceiver, a mobile network interface in communication with processor 210, a bus configured to facilitate communication between the various components of trading system 110, and a power source configured to power one or more components of trading system 110. A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general-purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™ low-energy Bluetooth™ (BLE), WiFi™, ZigBee™, ambient backscatter communications (ABC) protocols or similar technologies.

A mobile network interface may provide access to a cellular network, the Internet, or another wide-area network. In some embodiments, a mobile network interface may include hardware, firmware, and/or software that allows processor 210 to communicate with other devices via wired or wireless networks, whether local or wide area, private or public, as known in the art. A power source may be configured to provide an appropriate alternating current (AC) or direct current (DC) to power components.

As described above, trading system 110 may be configured to remotely communicate with one or more other devices, such as customer device 130 and/or 140.

Processor 210 may include one or more of a microprocessor, microcontroller, digital signal processor, co-processor or the like or combinations thereof capable of executing stored instructions and operating upon stored data. Memory 230 may include, in some implementations, one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like) for storing files, including an operating system, application programs (including, e.g., a web browser application, a widget or gadget engine, or other applications, as necessary), executable instructions, and data. In one embodiment, the processing techniques described herein are implemented as a combination of executable instructions and data within memory 230.

Processor 210 may be one or more known processing devices, such as a microprocessor from the Pentium™ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Trading system 110 may include one or more storage devices configured to store information used by processor 210 (or other components) to perform certain functions related to the disclosed embodiments. In one example, trading system 110 may include memory 230 that includes instructions to enable processor 210 to execute one or more applications, such as server applications, network communication processes, and any other type of application or software known to be available on computer systems. Alternatively, the instructions, application programs, etc., may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, trading system 110 may include memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, trading system 110 may include memory 230 that may include one or more programs 260 to perform one or more functions of the disclosed embodiments. Moreover, processor 210 may execute one or more programs 260 located remotely from trading system 110. For example, trading system 110 may access one or more remote programs 260, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational databases. Memory 230 may include software components that, when executed by processor 210, perform one or more processes consistent with the disclosed embodiments. In some embodiments, memory 230 may include database 250 for storing related data to enable trading system 110 to perform one or more of the processes and functionalities associated with the disclosed embodiments.

Trading system 110 may also be communicatively connected to one or more memory devices (e.g., databases (not shown)) locally or through a network. The remote memory devices may be configured to store information and may be accessed and/or managed by trading system 110. By way of example, the remote memory devices may be document management systems, Microsoft™ SQL database, SharePoint™ databases, Oracle™ databases, Sybase™ databases, or other relational databases. Systems and methods consistent with disclosed embodiments, however, are not limited to separate databases or even to the use of a database.

Trading system 110 may also include one or more I/O devices 220 that may include one or more interfaces for receiving signals or input from devices and providing signals or output to one or more devices that allow data to be received and/or transmitted by trading system 110. For example, trading system 110 may include interface components, which may provide interfaces to one or more input devices, such as one or more keyboards, mouse devices, touch screens, track pads, trackballs, scroll wheels, digital cameras, microphones, sensors, and the like, that enable trading system 110 to receive data from one or more users (such as via customer device 130 and/or 140).

In example embodiments of the disclosed technology, trading system 110 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While trading system 110 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations may include a greater or lesser number of components than those illustrated.

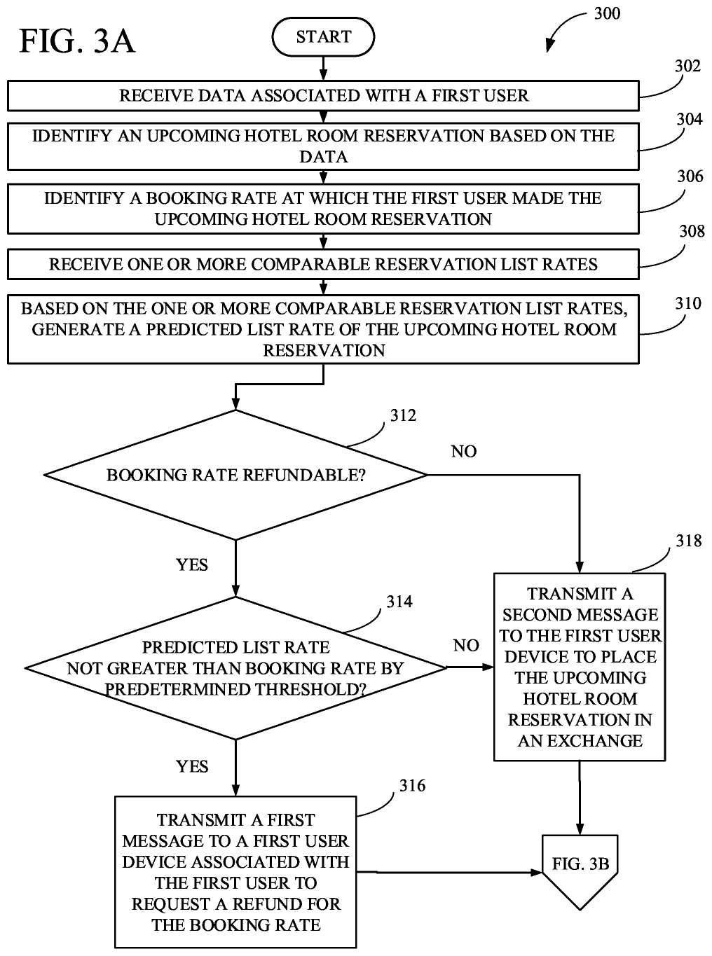

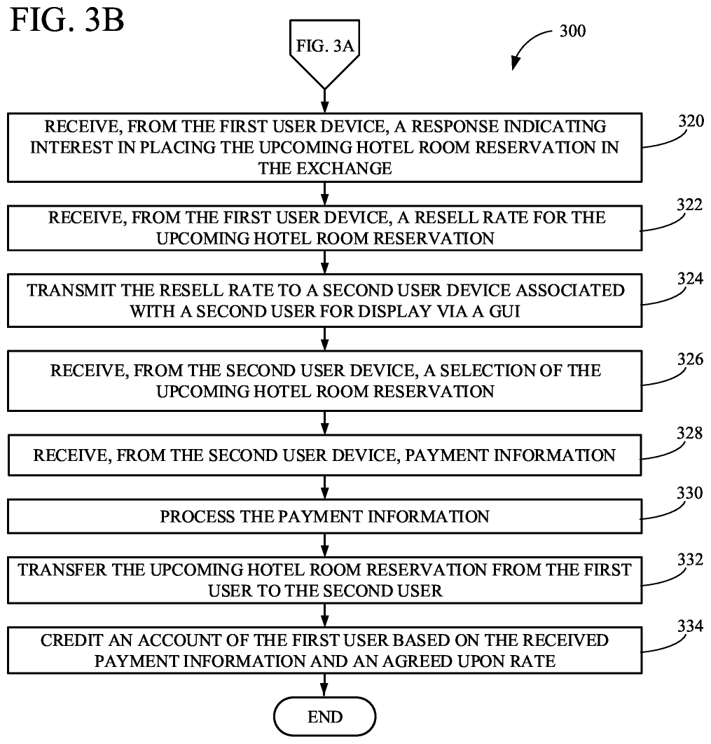

FIGS. 3A-3B show a flowchart of a method 300 for facilitating reservation trading. Method 300 may be performed by trading system 110, financial service provider system 120, customer device 130 and/or 140, and/or third-party system 160.

Starting with FIG. 3A, in block 302, the system (e.g., system 100) may receive data associated with a first user. For example, system 100 may be affiliated with a financial institution configured to receive transaction data associated with an account (e.g., credit, debit, etc.) associated with the first user. System 100 may receive this transaction data by, e.g., compiling account statements associated with the first user. The received data may cover a predefined period of time, e.g., six months, one year, etc. The received data may also comprise one or more types of data, such as rate information, location information, merchant information, transaction times, transaction dates, etc.

In block 304, the system (e.g., system 100) may identify an upcoming hotel room reservation based on the data. In other embodiments, this upcoming reservation may include a different type of reservation, such as a flight reservation, a restaurant reservation, a recreational activity reservation, and the like. That is, system 100 may filter the data by, e.g., date, time, location, merchant name, etc., to identify whether any portion of the data indicates association with an upcoming reservation. In some embodiments, system 100 may utilize a machine-learning model for training as to how to identify upcoming reservation information based on historical and/or current transaction data.

In block 306, the system (e.g., system 100) may identify a booking rate at which the first user made the upcoming hotel room reservation. System 100 may identify the booking rate using one of a variety of methods, such as by identifying the booking rate in the received transaction data, by retrieving the booking rate off an associated booking site (e.g., by utilizing a web crawler) based on received confirmation information (e.g., a confirmation code), or by receiving the booking rate directly from the first user. For example, system 100 may prompt the first user to input the booking rate via a GUI on a first customer device associated with the first user (e.g., customer device 130), or the first user may independently enter the booking rate as part of expressing interest in placing the upcoming hotel room reservation in an exchange (e.g., an online secondary marketplace), as discussed below with respect to block 320.

In block 308, the system (e.g., system 100) may receive one or more comparable reservation list rates. For example, system 100 may identify other reservations similar to the first user's upcoming hotel room reservation based on, e.g., hotel rating, location, booking season, etc. System 100 may then compile list rates of those other similar reservations. In some embodiments, system 100 may utilize a web crawler to pull in hotel room rate information from hotel websites or other booking websites (e.g., Expedia, TripAdvisor, Kayak, Google, etc.). In some embodiments, system 100 may utilize one or more integration or Application Programming Interface (API) connections with one or more booking sites to retrieve comparable reservation list rates.

In block 310, the system (e.g., system 100) may generate a predicted list rate of the upcoming hotel room reservation based on the one or more comparable reservation list rates. That is, system 100 may predict at what rate the first user's upcoming hotel room reservation could be posted or resold based on the current rates of the other similar reservations. System 100 may generate a predicted list rate based on market comparison data pertaining to, e.g., location, room size, number of nights on a reservation, reservation demand, hotel rating, hotel amenities, booking season, etc.

In block 312, the system (e.g., system 100) may determine whether the booking rate of the upcoming hotel room reservation is refundable. System 100 may identify whether there exists a refund policy associated with the upcoming hotel room reservation using one of a variety of methods, such as by utilizing a web crawler or a backend integration or API connection to retrieve the refund policy from the respective hotel or vendor's website, or by receiving the refund policy directly from the first user. For example, system 100 may prompt the first user to upload or provide a link to the policy via a GUI of customer device 130, or the first user may independently provide the policy as part of expressing interest in placing the upcoming hotel room reservation in the exchange, as discussed below with respect to block 320.

In block 314, the system (e.g., system 100) may determine whether the generated predicted list rate of the upcoming hotel room reservation is greater than the booking rate by a predetermined threshold. The predetermined threshold may be a percent difference, e.g., 10%, 15%, 25%, etc. The predetermined threshold may be automatically selected by system 100 as, e.g., a default setting, or may be selected by the first user, e.g., as a user preference of a user account within the exchange. If the predicted list rate is greater than the booking rate by the predetermined threshold, the first user may be able to make a desired profit by putting the upcoming hotel room reservation up for resale. If, however, the predicted list rate is not greater than the booking rate by the predetermined threshold, it may not be worthwhile (depending on the refund policy and/or the first user's desired profitability) for the first user to place the upcoming hotel room reservation up for resale.

In block 316, in response to determining that the upcoming hotel room reservation is refundable, and that the predicted list rate is not greater than the booking rate by the predetermined threshold, the system (e.g., system 100) may transmit a first message to the first customer device to suggest the first user request a refund for the booking rate. The first message may be in the form of, for example, an email, an SMS message, a push notification, an in-application message, etc.

In block 318, in response to determining either that the upcoming hotel room reservation is not refundable, or that the predicted list rate is greater than the booking rate by the predetermined threshold, the system (e.g., system 100) may transmit a second message to the first customer device to suggest the first user place the upcoming hotel room reservation in the exchange. The second message may be in one of the same forms as those discussed above with respect to the first message.

In some embodiments, regardless of whether system 100 transmits the first or the second message to the first user, system 100 may include suggestions for additional upcoming reservations that the first user may also wish to change or cancel. That is, as discussed above with respect to block 304, system 100 may identify many types of upcoming reservations based on the received transaction data, e.g., flight reservations, restaurant reservations, recreational activity reservations, etc. System 100 may be configured to recognize compatible reservations, i.e., reservations that match in terms of geographic location, time, and date (e.g., a flight to a given city, and a hotel and/or restaurant reservation booked in that city on compatible dates). In such case, system 100 may, in addition to suggesting the first user cancel a hotel reservation (either by requesting a refund or placing the hotel reservation in the resale exchange), system 100 may also suggest the first user cancel or modify other compatible reservations. In such case, system 100 may include these additional suggestions in either the first or second message, as described above with respect to blocks 316 and 318, respectively, or may transmit an additional message to the first user.

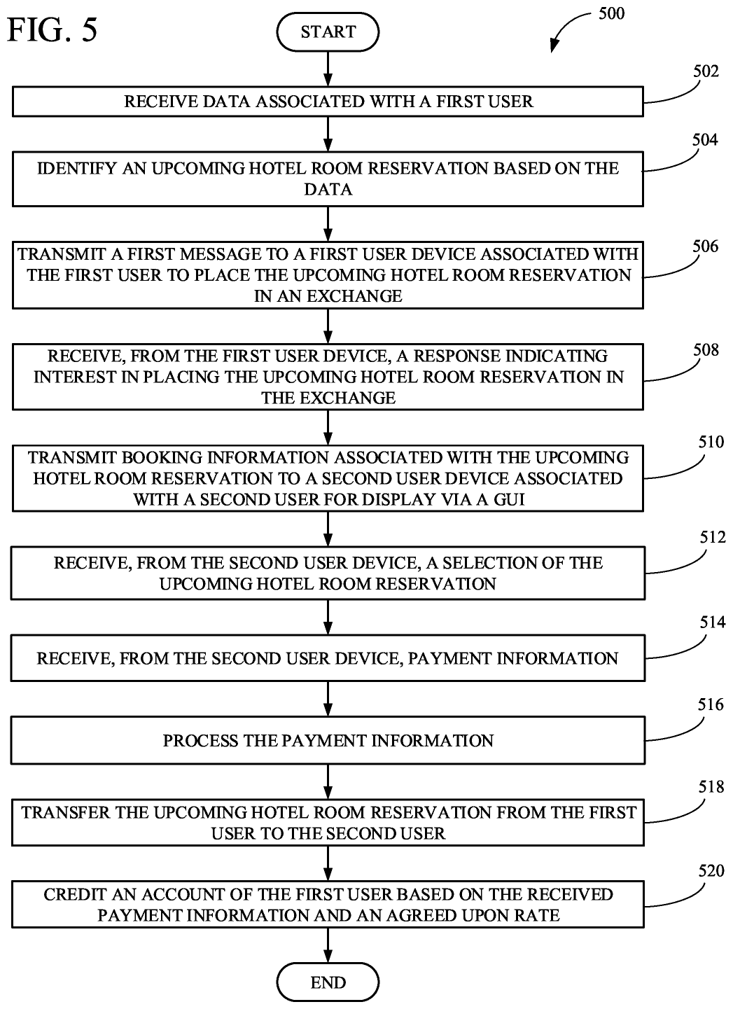

Turning to FIG. 3B, in block 320, the system (e.g., system 100) may receive a response from the first customer device indicating the first user's interest in placing the upcoming hotel room reservation in the exchange. System 100 may receive this response in one of a variety of ways, such as the first user creating an account and/or logging into the exchange via an online user profile, the first user selecting an input within a mobile device application, the first user selecting a link in an email, the first user initiating a contact with a chat bot within a program or application, etc. In some embodiments, as part of indicating interest in placing the upcoming hotel room reservation in the exchange, the first user may input booking information associated with the upcoming reservation, such as, reservation date(s), hotel name, hotel contact information (e.g., address, phone number, email address, etc.), booking rate, confirmation information (e.g., confirmation code), an associated refund or cancellation policy, etc. (as also described below with respect to block 510 of FIG. 5). In other embodiments, the response may instead indicate the first user's lack of interest in placing the upcoming hotel room reservation in the exchange.

In block 322, the system (e.g., system 100) may receive a resell rate from the first customer device for the upcoming hotel room reservation. The resell rate may be any rate at which the first user wishes to post the upcoming hotel room reservation for resale. For example, the first user may choose to place the upcoming hotel room reservation in the exchange at the generated predicted list rate, or any other rate the first user so chooses. System 100 may receive the resell rate from the first user via, e.g., inputted booking information (as discussed above), or a separate input.

In block 324, the system (e.g., system 100) may transmit the resell rate to a second customer device associated with a second user (e.g., customer device 140) for display via a GUI. That is, the system may provide a marketplace (e.g., trading system 110) wherein customers may post, view, search for, and select reservations for resale. For example, in some embodiments, once system 100 receives the resell rate from the first user (as described above with respect to block 322), system 100 may post that resell rate in a searchable listing that the second customer may access via the second customer device. In other embodiments, system 100 may send that resell rate directly to the second user via the second customer device if, for example, system 100 identifies the second user has previously searched for comparable upcoming reservations.

In block 326, the system (e.g., system 100) may receive, from the second customer device, a selection of the upcoming hotel room reservation. System 100 may receive this selection in one of a variety of ways, such as by recognizing the second user has created and/or logged into a user account in the exchange, recognizing the second user has selected an input button or link displayed adjacent to the upcoming hotel room reservation posting in a GUI, etc.

In block 328, the system (e.g., system 100) may receive payment information from the second customer device. For example, the second user may be prompted to enter credit or debit card information via a GUI of the second customer device to initiate payment for the upcoming hotel room reservation.

In block 330, the system (e.g., system 100) may process the received payment information. System 100 may handle payments directly (e.g., via financial service provider system 120), or may outsource the handling of payments to a third-party payment processor (e.g., PayPal, Square, Stripe, etc.).

In block 332, the system (e.g., system 100) may transfer the upcoming hotel room reservation from the first user to the second user. For example, system 100 may receive confirmation information as part of the first user's initial response indicating interest in placing the upcoming hotel room reservation in the exchange, as discussed above with respect to block 320. System 100 may also be configured to receive personal identification and/or contact information from the second user, such as via a user profile associated with the second user. Once payment information has been processed (in block 330, above), system 100 may then be configured to automatically provide the received confirmation information to the second user. System 100 may be configured to provide the received confirmation information in a variety of ways, such as by causing the second customer device to display the confirmation information in a new GUI, by generating a downloadable document including all confirmation information, by sending an email to the second user including all confirmation information, etc. System 100 may also be configured to allow the first and second users to communicate directly with one another (e.g., via an in-application messaging or chat feature) such that the first user may forward confirmation information for the upcoming hotel room reservation (e.g., a confirmation code) to the second user.

In block 334, the system (e.g., system 100) may credit an account of the first user based on the received payment information and an agreed upon rate. The account credited may be, for example, the first user's credit card account handled by the affiliated financial institution, as discussed above with respect to block 302, or may be a different account specified by the first user. The agreed upon rate may be, for example, the system generated predicted list rate, a resell rate selected by the first user, or a different rate altogether that may take into account additional fees, e.g., a processing fee required by system 100. In some embodiments, the first user may have already paid the full booking rate to the respective hotel (e.g., if the hotel required a full upfront payment). In such case, system 100 may be configured to receive the agreed upon rate from the second user, and to credit the agreed upon rate to the first user. In other embodiments, the first user may have already paid a portion of the booking rate to the respective hotel (e.g., if the hotel required an initial deposit). In such case, system 100 may be configured to receive the agreed upon rate from the second user, and to credit a first portion of the agreed upon rate (e.g., the portion the first user already paid to the respective hotel, plus any difference between the booking rate and the agreed upon rate) to the first user, while transmitting a second portion of the agreed upon rate (e.g., the remaining portion of the booking rate not yet paid) to the hotel. In other embodiments, the first user may not have yet paid any portion of the booking rate to the respective hotel. In such case, system 100 may be configured to receive the agreed upon rate from the second user, and to credit a first portion of the agreed upon rate (e.g., the difference between the booking rate and the agreed upon rate) to the first user, while transmitting the booking rate amount to the respective hotel.

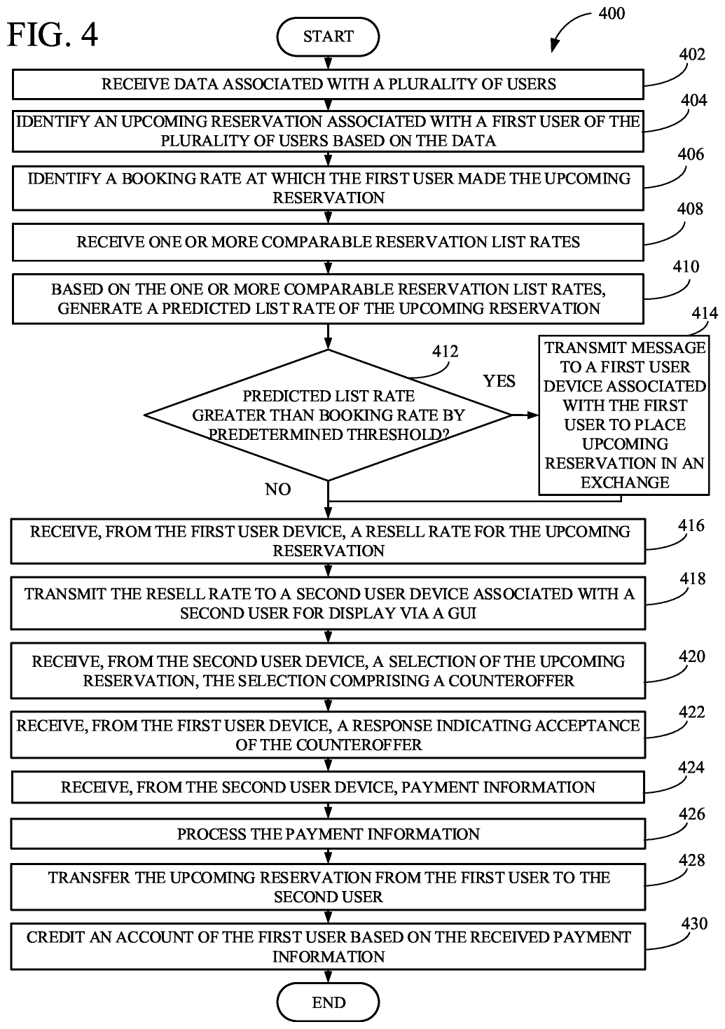

FIG. 4 shows a flowchart of a method 400 for facilitating reservation trading. Method 400 may also be performed by trading system 110, financial service provider system 120, customer device 130 and/or 140, and/or third-party system 160. Method 400 is similar to method 300 of FIGS. 3A-3B except that method 400 also includes blocks 420 and 422. The descriptions of blocks 402, 404, 406, 408, 410, 412, 414, 416, 418, 424, 426, 428, and 430 of method 400 are the same as or similar to the respective descriptions of blocks 302, 304, 306, 308, 310, 314, 318, 322, 324, 328, 330, 332, and 334 of method 300, and as such, are not repeated herein for brevity.

In block 420 of FIG. 4, the system (e.g., system 100) may receive, from the second customer device, a selection of the upcoming reservation, wherein the selection comprises a counteroffer. That is, rather than accepting the first user's resell rate offer, the second user may instead respond with a counteroffer rate. For example, if the first user offers the upcoming reservation at a resell rate of $300, the second user may respond with a counteroffer of $275.

In block 422 of FIG. 4, the system (e.g., system 100) may receive, from the first customer device, a response indicating acceptance of the counteroffer. In another embodiment, rather than immediately accepting the second user's counteroffer, the first user may respond with yet another revised offer for the upcoming reservation such that the first and second users conduct a negotiation. For example, in response to the second user's counteroffer of $275, the first user may respond with a revised offer of $290. With respect to both blocks 420 and 422, the first and second users may send and receive offers and counteroffers to one another via, e.g., in-application messaging or notifications, SMS messaging, email, etc.

FIG. 5 shows a flowchart of a method 500 for facilitating reservation trading. Method 500 may also be performed by trading system 110, financial service provider system 120, customer device 130 and/or 140, and/or third-party system 160. Method 500 is similar to method 300 of FIGS. 3A-3B except that method 500 also includes block 510. The description of blocks 502, 504, 506, 508, 512, 514, 516, 518, and 520 of method 500 are the same as or similar to the respective descriptions of blocks 302, 304, 318, 320, 326, 328, 330, 332, and 334 of method 300, and as such, are not repeated herein for brevity.

In block 510 of FIG. 5, the system (e.g., system 100) may transmit booking information associated with the upcoming hotel room reservation to a second customer device associated with a second user (e.g., customer device 140) for display via a GUI. As also discussed above with respect to block 320 of FIG. 3, the booking information may comprise one or more types of information, such as reservation date(s), entity name, entity contact information, booking rate, confirmation information (e.g., confirmation code), a user name, a resell rate, an associated refund or cancellation policy, etc. Transmitting this booking information to the second customer device may allow the second user to make an informed choice as to whether to select the upcoming hotel room reservation (block 512). System 100 may first receive this booking information from the first user, as described above with respect to block 320 of FIG. 3.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to customer devices that may include mobile computing devices. Those skilled in the art will recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Example Use Case

The following example use case describes an example of a typical user flow pattern. It is intended solely for explanatory purposes and not in limitation.

In one example, an online exchange system may be available for customers to transfer booked hotel room reservations to one another. The system may be associated with a financial institution, and may be configured to receive data, such as transaction data, associated with a first user. This transaction data may indicate times, dates, locations, merchants, etc., associated with each transaction the first user conducted over, e.g., a six-month period. For example, the first user may have a credit card account with the financial institution such that the financial institution has a record of all transactions conducted by the first user using the credit card account. Based on the transaction data, the system may automatically recognize that the first user made a hotel room reservation by, for example, identifying the name “Hampton Inn” as part of one or more transactions on the first user's credit card statements. The system may also be able to recognize the date for which this reservation was made, and the booking rate of the reservation, e.g., $300. The system may then be configured to compile current room rates for other comparable hotel room reservations by utilizing a web crawler to pull information off other hotel websites. For example, the system may identify several other hotels with similar star ratings (e.g., Hilton, Holiday Inn, etc.) in the same general geographic region as the first user's Hampton Inn reservation. The system may also identify rates of these comparable hotels within the same time frame or season as the first user's Hampton Inn reservation (e.g., summer, fall, etc.). Based on these comparable rates, the system may generate a predicted list rate of the first user's Hampton Inn reservation. That is, while the first user may have originally booked the Hampton Inn room for $300, based on the current rates at other comparable hotels, the first user's Hampton Inn room reservation may now be worth $350. The system may then be configured to determine whether the first user's Hampton Inn reservation is refundable, i.e., whether the first user may cancel the reservation to get back the full $300 booking rate. The system may make this determination by prompting the first user, via a GUI of the first user's mobile device, to upload the associated refund policy. The system may also determine whether the $350 predicted list rate is greater than the $300 booking rate by a predetermined threshold. This predetermined threshold might be, e.g., 15%, as indicated by a pre-selected user preference in the first user's account within the online exchange.

In this case, the system may determine, based on the uploaded refund policy, that the first user's Hampton Inn reservation is refundable. However, the system may also determine that the first user's pre-selected 15% threshold is satisfied as the predicted list rate of $350 is greater than the $300 booking rate by at least 15%. As such, the system may transmit a message to the first user, e.g., via a GUI on the first user's mobile device, suggesting the first user place the upcoming Hampton Inn reservation for resale in the online exchange. The first user may then express interest in placing the Hampton Inn reservation in the online exchange by logging into the first user's exchange account via the first user's mobile device. The first user may, via a series of inputs on one or more displays within the online exchange, enter booking information associated with the reservation, e.g., hotel name, reservation date(s), confirmation code, a resell rate, etc. The entered resell rate may be the rate at which the first user wishes to resell the reservation, e.g., the predicted list rate of $350. A second user, via the second user's mobile device, may then log into the same online application, search for upcoming available hotel room reservations on specific date(s), and select the first user's Hampton Inn reservation for purchase from a list of options. As part of the second user's selection, the second user may also enter, via an input field of a GUI on the second user's mobile device, a counteroffer rate of $325. The first user may then receive a pop-up notification within the online application informing the first user of the second user's counteroffer. The first user may then accept the second user's counteroffer rate by clicking on a link provided adjacent to the pop-up notification.

The second user may then be prompted to enter payment information, e.g., credit card information, into a GUI of the second user's mobile device. The system may then process the payment information. The system may then transfer the Hampton Inn reservation from the first user to the second user by generating a document, downloadable via a GUI of the second user's mobile device, containing the booking information associated with the Hampton Inn reservation such that the second customer may contact Hampton Inn to change the name and payment information associated with the reservation. Finally, the system may credit an account of the first user, such as the first user's credit card account with the financial institution, in the amount of $25, the difference between the agreed upon rate and the original booking rate, or the first user's profit.

What is claimed is:

1. A system, comprising:
one or more processors; and
a memory in communication with the one or more processors and storing instructions that, when executed by the one or more processors, are configured to cause the system to:
receive data associated with a first user;
identify an upcoming hotel room reservation based on the data;
identify a booking rate at which the first user made the upcoming hotel room reservation;
receive one or more comparable reservation list rates;
based on the one or more comparable reservation list rates, generate a predicted list rate of the upcoming hotel room reservation;
determine whether the predicted list rate of the upcoming hotel room reservation is greater than the booking rate by a predetermined threshold;
determine, based on a refund policy associated with the upcoming hotel room reservation, whether the booking rate is refundable;
responsive to determining the booking rate is refundable and the predicted list rate is not greater than the booking rate by the predetermined threshold:
transmit a first message to a first customer device associated with the first user to request a refund for the booking rate;
responsive to determining the booking rate is not refundable or the predicted list rate is greater than the booking rate by the predetermined threshold:
transmit a second message to the first customer device to place the upcoming hotel room reservation in an exchange;
receive, from the first customer device, a response indicating interest in placing the upcoming hotel room reservation in the exchange;
receive, from the first customer device, a resell rate for the upcoming hotel room reservation;
transmit the resell rate to a second customer device associated with a second user for display via a graphical user interface (GUI);
receive, from the second customer device, a selection of the upcoming hotel room reservation;
receive, from the second customer device, first payment information;
process the first payment information;
transfer the upcoming hotel room reservation from the first user to the second user; and
credit an account of the first user based on the received first payment information and an agreed upon rate.

2. The system of claim 1, wherein the data covers a predefined period of time.

3. The system of claim 1, wherein the data comprises one or more of rate information, location information, merchant information, transaction time, transaction date, or combinations thereof.

4. The system of claim 1, wherein the predetermined threshold comprises a percent difference between the predicted list rate and the booking rate.

5. The system of claim 1, wherein the agreed upon rate is equal to the resell rate.

6. The system of claim 1, wherein the selection of the upcoming hotel room reservation comprises a counteroffer and the agreed upon rate is equal to the counteroffer.

7. The system of claim 1, wherein the instructions are further configured to cause the system to:
identify, via a web crawler, the refund policy associated with the upcoming hotel room reservation.

8. A system, comprising:
one or more processors; and
a memory in communication with the one or more processors and storing instructions that, when executed by the one or more processors, are configured to cause the system to:
receive data associated with a plurality of users;
identify an upcoming reservation associated with a first user of the plurality of users based on the data;
identify a booking rate at which the first user made the upcoming reservation;
receive one or more comparable reservation list rates;
based on the one or more comparable reservation list rates, generate a predicted list rate of the upcoming reservation;
determine whether the predicted list rate of the upcoming reservation is greater than the booking rate by a predetermined threshold;
responsive to determining the predicted list rate is greater than the booking rate by the predetermined threshold, transmit a first message to a first customer device associated with the first user to place the upcoming reservation in an exchange;
receive, from the first customer device, a resell rate for the upcoming reservation;
transmit the resell rate to a second customer device associated with a second user for display via a graphical user interface (GUI);
receive, from the second customer device, a selection of the upcoming reservation, the selection comprising a counteroffer;
receive, from the first customer device, a response indicating acceptance of the counteroffer;
receive, from the second customer device, first payment information;
process the first payment information;
transfer the upcoming reservation from the first user to the second user; and
credit an account of the first user based on the received first payment information.

9. The system of claim 8, wherein the data covers a predefined period of time.

10. The system of claim 8, wherein the data comprises one or more of rate information, location information, merchant information, transaction time, transaction date, or combinations thereof.

11. The system of claim 8, wherein the predetermined threshold comprises a percent difference between the predicted list rate and the booking rate.

12. The system of claim 8, wherein the instructions are further configured to cause the system to:
identify, via a web crawler, a refund policy associated with the upcoming reservation;
determine, based on the refund policy, whether the booking rate is refundable;
responsive to determining the booking rate is refundable and the predicted list rate is not greater than the booking rate by the predetermined threshold:
transmit a second message to the first customer device to request a refund for the booking rate; and
responsive to determining the booking rate is not refundable or the predicted list rate is greater than the booking rate by the predetermined threshold:
transmit a third message to the first customer device to place the upcoming reservation in the exchange.

13. A system, comprising:
one or more processors; and
a memory in communication with the one or more processors and storing instructions that, when executed by the one or more processors, are configured to cause the system to:
receive data associated with a first user;
identify an upcoming hotel room reservation based on the data;
transmit a first message to a first customer device associated with the first user to place the upcoming hotel room reservation in an exchange;
receive, from the first customer device, a response indicating interest in placing the upcoming hotel room reservation in the exchange;
transmit booking information associated with the upcoming hotel room reservation to a second customer device associated with a second user for display via a graphical user interface (GUI);
receive, from the second customer device, a selection of the upcoming hotel room reservation;
receive, from the second customer device, first payment information;
process the first payment information;
transfer the upcoming hotel room reservation from the first user to the second user; and
credit an account of the first user based on the received first payment information and an agreed upon rate.

14. The system of claim 13, wherein the instructions are further configured to cause the system to:
identify a booking rate at which the first user made the upcoming hotel room reservation;
receive one or more comparable reservation list rates;
based on the one or more comparable reservation list rates, generate a predicted list rate of the upcoming hotel room reservation; and
determine whether the predicted list rate of the upcoming hotel room reservation is greater than the booking rate by a predetermined threshold.

15. The system of claim 14, wherein transmitting the first message to the first customer device is based on determining the predicted list rate is greater than the booking rate by the predetermined threshold.

16. The system of claim 14, wherein the instructions are further configured to cause the system to:
identify, via a web crawler, a refund policy associated with the upcoming hotel room reservation;
determine, based on the refund policy, whether the booking rate is refundable;
responsive to determining the booking rate is refundable and the predicted list rate is not greater than the booking rate by the predetermined threshold:
transmit a second message to the first customer device to request a refund for the booking rate; and
responsive to determining the booking rate is not refundable or the predicted list rate is greater than the booking rate by the predetermined threshold:
transmit a third message to the first customer device to place the upcoming hotel room reservation in the exchange.

17. The system of claim 13, wherein the booking information comprises one or more of an entity name, a hotel name, a hotel address, a hotel phone number, a confirmation code, a booking rate, a resell rate, a transaction date, a transaction time, a user name, or combinations thereof.

18. The system of claim 13, wherein the booking information comprises a resell rate and the agreed upon rate is equal to the resell rate.

19. The system of claim 13, wherein the selection of the upcoming hotel room reservation comprises a counteroffer.

20. The system of claim 19, wherein the agreed upon rate is equal to the counteroffer.
